(19) United States
(12) Patent Application Publication
(10) Pub. No.: US 2025/0166364 A1
(43) Pub. Date: May 22, 2025

(54) GENERATIVE ARTIFICIAL INTELLIGENCE BASED TRAJECTORY SIMULATION

(71) Applicant: TuSimple, Inc., SAN DIEGO, CA (US)

(72) Inventors: Hao XIAO, San Diego, CA (US); Yiqian GAN, San Diego, CA (US); Xin YE, San Diego, CA (US); Dongqiangzi YE, San Diego, CA (US); JingHao MIAO, San Mateo, CA (US); Lingting GE, San Diego, CA (US)

(21) Appl. No.: 18/518,222

(22) Filed: Nov. 22, 2023

(51) Int. Cl. G06V 10/82; G06V 20/58

(52) U.S. Cl. CPC G06V 10/82; G06V 20/58

(57) ABSTRACT

Devices, systems, and methods a method for simulating a trajectory of an object are described. An example method includes obtaining a context feature representation corresponding to context information, wherein the context information comprises information describing an environment of the object; obtaining a control feature representation corresponding to control information, wherein the control information comprises information that the simulated trajectory needs to satisfy; determining a latent variable using an input encoder based on the context feature representation and the control feature representation; and determining the simulated trajectory by inputting the latent variable, the context feature representation, and the control feature representation into a decoder.

### TECHNICAL FIELD

This document relates to tools (systems, apparatuses, methodologies, computer program products, etc.) for generating trajectories by AI-based simulation.

### BACKGROUND

Autonomous vehicle navigation is a technology for sensing the position and movement of a vehicle and, based on the sensing, autonomously control the vehicle to navigate towards a destination. Autonomous vehicle control and navigation can have important applications in transportation of people, goods and services. Efficiently generating commands for the powertrain of a vehicle that enable its accurate control is paramount for the safety of the vehicle and its passengers, as well as people and property in the vicinity of the vehicle, and for the operating efficiency of driving missions.

### SUMMARY

Aspects of the present document relates to devices, systems, and methods for simulating a trajectory of an object.

One aspect of the present document relates to an example method for simulating a trajectory of an object. The example method includes: obtaining a context feature representation corresponding to context information, wherein the context information comprises information describing an environment of the object; obtaining a control feature representation corresponding to control information, wherein the control information comprises information that the simulated trajectory needs to satisfy; determining a latent variable using an input encoder based on the context feature representation and the control feature representation; and determining the simulated trajectory by inputting the latent variable, the context feature representation, and the control feature representation into a decoder.

One aspect of the present document relates to an example method for training a neural network configured to simulate a trajectory of an object. The example method includes: obtaining a plurality of training datasets, each of which includes training context information that includes information describing a training environment of the training object, a training trajectory of a training object, and training operation information that includes information describing a training operation of the training object while the training object traverses the training trajectory, training the neural network based on the plurality of training datasets, wherein the training comprises: determining, using the neural network being trained, pairs of simulation results each of which includes a simulated latent variable and a corresponding simulated training trajectory and corresponds to one of the plurality of training dataset; and updating the neural network being trained based on a loss function relating to: (a) a difference between a distribution of the simulated latent variables and a distribution of latent variables corresponding to the training trajectories, and (b) a reconstruction loss relating to differences between the simulated training trajectories and corresponding training trajectories.

One aspect of the present document relates to an example method for simulating an environment comprising a plurality of objects. The example method includes: for each of at least one of the plurality of objects, generating a simulated trajectory according to the method of any one or more of the solutions disclosed herein.

One aspect of the present document relates to an example system including memory storing computer program instructions; and one or more processors configured to execute the computer program instructions to effectuate the methods as described herein. One aspect of the present document relates to one or more non-transitory computer-readable storage media having code stored thereupon, the code, upon execution by at least one processor causing the at least one processor to implement the methods as described herein.

The above and other aspects and features of the disclosed technology are described in greater detail in the drawings, the description, and the claims.

### BRIEF DESCRIPTION OF THE DRAWINGS

FIG. 1 illustrates a block diagram of an example vehicle ecosystem according to some embodiments of the present document.

FIG. 2A depicts example merge scenarios according to some embodiments of the present document.

FIG. 2B illustrates an example merge scenario according to some embodiments of the present document.

FIG. 2C illustrates an example of a distribution of merging distances according to some embodiments of the present document.

FIG. 3A illustrates a mapping function for Learning from Demonstration (LfD).

FIG. 3B illustrates a reinforcement learning (RL)-like method for LfD.

FIG. 4A illustrates an architecture of a Variational Autoencoder (VAE).

FIG. 4B illustrates an architecture of a Conditional Variational Autoencoder (CVAE).

FIG. 5 illustrates a CVAE framework for behavior simulation (e.g., trajectory simulation) in traffic merge according to some embodiments of the present document.

FIG. 6. Illustrates an example merge structure according to some embodiments of the present document.

FIG. 7 depicts an example of a context encoder according to some embodiments of the present disclosure.

FIG. 8 depicts an example of a distance encoder according to some embodiments of the present disclosure.

FIG. 9 depicts an example of a merge-in trajectory encoder according to some embodiments of the present disclosure.

FIG. 10 depicts an example of a CVAE encoder according to some embodiments of the present disclosure.

FIG. 11 depicts an example of a CVAE decoder according to some embodiments of the present disclosure.

FIG. 12 illustrates an example of a hardware platform that can implement some methods and techniques described in the present document.

FIG. 13 illustrates a flowchart of a process for simulating a trajectory of an object according to some embodiments of the present document.

FIG. 14 illustrates a flowchart of a process for training a neural network configured to simulate a trajectory of an object according to some embodiments of the present document.

FIG. 15 depicts an example of a loss function according to some embodiments of the present disclosure.

### DETAILED DESCRIPTION

The transportation industry has been undergoing considerable changes in the way technology is used to control the operation of vehicles. As exemplified in the automotive passenger vehicle, there has been a general advancement towards shifting more of the operational and navigational decision making away from the human driver and into on-board computing power. This is exemplified in the extreme by the numerous under-development autonomous vehicles. Current implementations are in intermediate stages, such as the partially-autonomous operation in some vehicles (e.g., autonomous acceleration and navigation, but with the requirement of a present and attentive driver), the safety-protecting operation of some vehicles (e.g., maintaining a safe following distance and automatic braking), the safety-protecting warnings of some vehicles (e.g., blind-spot indicators in side-view mirrors and proximity sensors), as well as ease-of-use operations (e.g., autonomous parallel parking).

Different types of autonomous vehicles have been classified into different levels of automation under the Society of Automotive Engineers' (SAE) J3016 standard, which ranges from Level 0 in which the vehicle has no automation to Level 5 (L5) in which the vehicle has full autonomy. In an example, SAE Level 4 (L4) is characterized by the vehicle operating without human input or oversight but only under select conditions defined by factors such as road type or geographic area. In order to achieve SAE L4 autonomy, vehicle control commands must be efficiently computed while collaborating with both the high-level mission planner and the low-level powertrain characteristics and capabilities.

The control of autonomous vehicles is a complicated task, involving coordination of multiple modules of an autonomous driving system. Such an autonomous driving system needs to be tested rigorously before implementation, and may be updated when more information (e.g., runtime data from road trips), new hardware (e.g., sensors), or the like, or a combination thereof, becomes available. For example, when more road tests are performed from which more runtime data becomes available, algorithms of one or more software modules may be improved with respect to, e.g., object detection, handling of various traffic and/or weather conditions, handling of edge cases, or the like, or a combination thereof. As another example, when better hardware (e.g., sensors with better temporal and/or spatial resolution, processors with improved computational capacities, faster data transmission within the system, more powerful powertrain, etc.) becomes available and/or computationally/commercially feasible, one or more software modules may need to be adjusted accordingly. In some cases, it is expensive, dangerous, and/or infeasible to robustly test an autonomous driving system in real-world driving environments. Instead, simulators can be used.

Merely by way of example, an autonomous driving system may be trained to handle a merge situation which may occur when a vehicle where the autonomous driving system is implemented (or referred to as a target vehicle) is driving in a right-most lane (in the US) of a highway, with an onramp connecting from right (in left-driving countries, such a situation will arise in a left-most lane of the highway) or when the vehicle is driving in a lane next to at least one other lane. The vehicle may need to decide an optimal gap to allow a merging vehicle to merge into the highway. Current implementations of merge window determination suffer from poor performance along large curvature due to limitations in perception and/or when there is heavy traffic. In a heavy traffic with multiple objects around the target vehicle, some vehicular interactions may be missed. One desirable target is to reduce number of frames needed to select a merge window, while at the same time increase the number of frames where the merge window is correctly selected. Another design goal is to reduce or minimize collision probability. A further design objective is to ensure smoothness in trajectory of the target vehicle or another vehicle that is attempting to merge.

To achieve these and other design goals, the autonomous driving system may be trained to handle the merge situation in a simulated environment including one or more objects. Trajectories of the one or more objects may need to be provided to create a simulated environment. Some embodiments of the present document include systems and methods for simulating a trajectory of an object. In some embodiments, the example method includes: obtaining a context feature representation corresponding to context information, wherein the context information comprises information describing an environment of the object; obtaining a control feature representation corresponding to control information, wherein the control information comprises information that the simulated trajectory needs to satisfy; determining a latent variable using an input encoder based on the context feature representation and the control feature representation; and determining the simulated trajectory by inputting the latent variable, the context feature representation, and the control feature representation into a decoder.

Simulation may allow for the testing of autonomous driving algorithms in various scenarios, including challenging and hazardous scenarios, without putting anyone at risk. This includes dangerous driving behaviors of objects in the surroundings of the target vehicle. E.g., an object may merge with a dangerously short merge distance. Such cases may be rare in real world, but may be simulated based on relevant parameters (e.g., by specifying a merge distance and/or aggressiveness of an object). Simulations enable quick iterations of autonomous driving algorithms. Engineers can modify parameters or algorithms and immediately test the outcomes, speeding up the development process significantly. It's more cost-effective to simulate various environments and conditions than to recreate them in the real world. In simulations, aspects of the environment and scenario can be controlled and repeated. This reproducibility may facilitate the debugging and improvement of algorithms, as it allows for consistent comparison between different versions of the software. Regulatory bodies may require evidence that autonomous vehicles can handle a wide range of scenarios safely. Simulations can provide this evidence by demonstrating how the vehicle would behave in countless hypothetical situations.

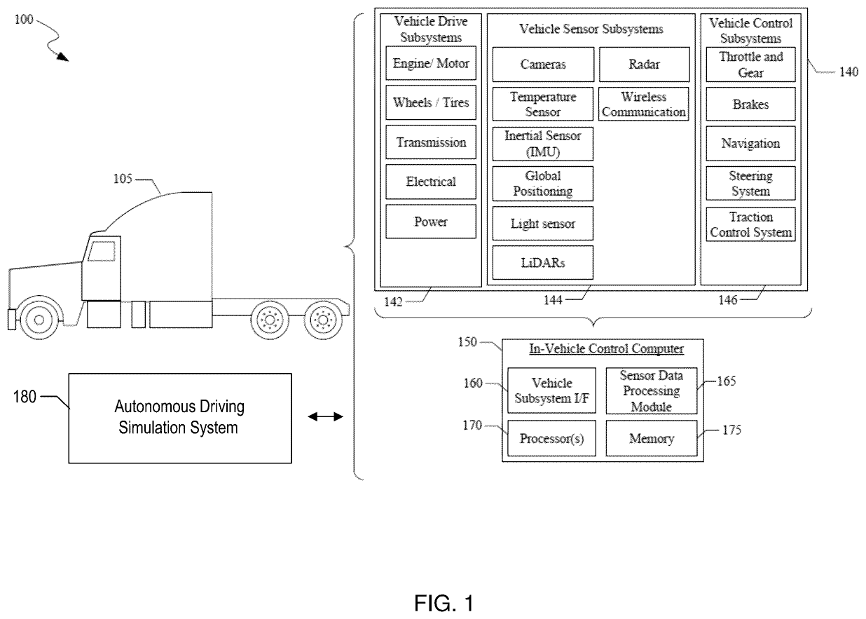

FIG. 1 illustrates a block diagram of an example vehicle ecosystem according to some embodiments of the present disclosure. The system 100 may include an autonomous vehicle 105, such as a tractor unit of a semi-trailer truck. The autonomous vehicle 105 may include a plurality of vehicle subsystems 140 and an in-vehicle control computer 150. The plurality of vehicle subsystems 140 can include, for example, vehicle drive subsystems 142, vehicle sensor subsystems 144, and vehicle control subsystems 146. FIG. 1 shows several devices or systems being associated with the autonomous vehicle 105. In some embodiments, additional devices or systems may be added to the autonomous vehicle 105, and in some embodiments, some of the devices or systems shown in FIG. 1 may be removed from the autonomous vehicle 105.

An engine/motor, wheels and tires, a transmission, an electrical subsystem, and/or a power subsystem may be included in the vehicle drive subsystems 142. The engine/motor of the autonomous truck may be an internal combustion engine (or gas-powered engine), a fuel-cell powered electric engine, a battery powered electric engine/motor, a hybrid engine, or another type of engine capable of actuating the wheels on which the autonomous vehicle 105 (also referred to as vehicle 105 or truck 105) moves. The engine/motor of the autonomous vehicle 105 can have multiple engines to drive its wheels. For example, the vehicle drive subsystems 142 can include two or more electrically driven motors.

The transmission of the vehicle 105 may include a continuous variable transmission or a set number of gears that translate power created by the engine of the vehicle 105 into a force that drives the wheels of the vehicle 105. The vehicle drive subsystems 142 may include an electrical system that monitors and controls the distribution of electrical current to components within the vehicle drive subsystems 142 (and/or within the vehicle subsystems 140), including pumps, fans, actuators, in-vehicle control computer 150 and/or sensors (e.g., cameras, LiDARs, RADARs, etc.). The power subsystem of the vehicle drive subsystems 142 may include components which regulate a power source of the vehicle 105.

Vehicle sensor subsystems 144 can include sensors which are used to support general operation of the autonomous truck 105. The sensors for general operation of the autonomous vehicle may include, for example, one or more cameras, a temperature sensor, an inertial sensor, a global positioning system (GPS) receiver, a light sensor, a LiDAR system, a radar system, and/or a wireless communications system.

The vehicle control subsystems 146 may include various elements, devices, or systems including, e.g., a throttle, a brake unit, a navigation unit, a steering system, and an autonomous control unit. The vehicle control subsystems 146 may be configured to control operation of the autonomous vehicle, or truck, 105 as a whole and operation of its various components. The throttle may be coupled to an accelerator pedal so that a position of the accelerator pedal can correspond to an amount of fuel or air that can enter the internal combustion engine. The accelerator pedal may include a position sensor that can sense a position of the accelerator pedal. The position sensor can output position values that indicate the positions of the accelerator pedal (e.g., indicating the amount by which the accelerator pedal is actuated).

The brake unit can include any combination of mechanisms configured to decelerate the autonomous vehicle 105. The brake unit can use friction to slow the wheels of the vehicle in a standard manner. The brake unit may include an anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically based on, e.g., traffic or road conditions, while, e.g., the autonomous vehicle 105 is in operation. In some embodiments, the navigation unit may be configured to incorporate data from a GPS device and one or more predetermined maps so as to determine the driving path for the autonomous vehicle 105. The steering system may represent any combination of mechanisms that may be operable to adjust the heading of the autonomous vehicle 105 in an autonomous mode or in a driver-controlled mode of the vehicle operation.

The traction control system (TCS) may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

The autonomous control unit may include a control system (e.g., a computer or controller comprising a processor) configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some example embodiments, the autonomous control unit may be configured to incorporate data from the GPS device, the radar, the LiDAR, the cameras, and/or other vehicle sensors and subsystems to determine the driving path or trajectory for the autonomous vehicle 105.

An in-vehicle control computer 150, which may be referred to as a vehicle control unit or VCU, can include, for example, any one or more of: a vehicle subsystem interface 160, a map data sharing module 165, a driving operation module 168, one or more processors 170, and/or memory 175. This in-vehicle control computer 150 may control many, if not all, of the operations of the autonomous truck 105 in response to information from the various vehicle subsystems 140. The memory 175 may contain processing instructions (e.g., program logic) executable by the processor(s) 170 to perform various methods and/or functions of the autonomous vehicle 105, including those described in this patent document. For instance, the data processor 170 executes the operations associated with vehicle subsystem interface 160, map data sharing module 165, and/or driving operation module 168. The in-vehicle control computer 150 can control one or more elements, devices, or systems in the vehicle drive subsystems 142, vehicle sensor subsystems 144, and/or vehicle control subsystems 146. For example, the driving operation module 168 in the in-vehicle control computer 150 may operate the autonomous vehicle 105 in an autonomous mode in which the driving operation module 168 can send instructions to various elements or devices or systems in the autonomous vehicle 105 to enable the autonomous vehicle to drive along a determined trajectory. For example, the driving operation module 168 can send instructions to the steering system to steer the autonomous vehicle 105 along a trajectory, and/or the driving operation module 168 can send instructions to apply an amount of brake force to the brakes to slow down or stop the autonomous vehicle 105.

The map data sharing module 165 can be also configured to communicate and/or interact via a vehicle subsystem interface 160 with the systems of the autonomous vehicle. The map data sharing module 165 can, for example, send and/or receive data related to the trajectory of the autonomous vehicle 105 as further explained in Section II. The vehicle subsystem interface 160 may include a software interface (e.g., application programming interface (API)) through which the map data sharing module 165 and/or the driving operation module 168 can send or receive information to one or more devices in the autonomous vehicle 105.

The memory 175 may include instructions to transmit data to, receive data from, interact with, or control one or more of the vehicle drive subsystems 142, vehicle sensor subsystems 144, or vehicle control subsystems 146. The in-vehicle control computer (VCU) 150 may control the operation of the autonomous vehicle 105 based on inputs received by the VCU from various vehicle subsystems (e.g., the vehicle drive subsystems 142, the vehicle sensor subsystems 144, and the vehicle control subsystems 146). The VCU 150 may, for example, send information (e.g., commands, instructions or data) to the vehicle control subsystems 146 to direct or control functions, operations or behavior of the autonomous vehicle 105 including, e.g., its trajectory, velocity, steering, braking, and signaling behaviors. The vehicle control subsystems 146 may receive a course of action to be taken from one or more modules of the VCU 150 and may, in turn, relay instructions to other subsystems to execute the course of action.

In some embodiments of the disclosed technology, an autonomous driving simulation system 180 can be used for training and validation of an autonomous driving system, such as the vehicle drive subsystem 142 and the vehicle control subsystem 146. The disclosed technology can be implemented in some embodiments to provide an autonomous driving simulation system 180 that can allow a user to control multiple aspects related to the simulation, including traffic patterns and driver/pedestrian behaviors.

In some embodiments, the autonomous driving simulation system 180 may include an artificial intelligence (AI) agent system configured to allow the creation of external vehicles/objects/pedestrians with desired behaviors to generate simulation scenarios that are used to test autonomous vehicles and their vehicle drive subsystems and vehicle control subsystems.

In some embodiments, a desired behaviors of an external vehicle/object/pedestrian that can be generated by the AI agent system include one or more of: dynamically decelerating/accelerating toward a target speed; cruise control with a specific time or space gap from a front vehicle; collision avoidance within defined parameters; a defined trajectory with realistic vehicle kinematics; reaction with vehicles within a specified perception range; lane keeping with a specific offset with respect to a center, a left boundary, and/or a right boundary of the lane; negotiating merging and lane changing/lane keeping/cutting in; swerving/turning with a specific parameter; or switching/changing a behavior dynamically according to the surroundings.

The disclosed technology can be implemented in some embodiments to generate an AI-simulated agent behavior without being limited by, e.g., traffic/vehicle/object/pedestrian behaviors that can be seen, unseen, or rarely seen in real life. Notably, the AI agent system implemented based on some embodiments can mimic and integrate the real-life behavior by learning from gathered data. For example, a simulated behavior of an object may closely mimic a real-world behavior of a vehicle (the same object whose behavior is the subject of the simulation or a different object), including a real-time adjustment in its behavior in response to behaviors of another object (e.g., an ego vehicle, an agent vehicle) or the traffic condition in the surroundings of the vehicle. Merely by way of example, a vehicle decelerates after changing its intention from merging into traffic to waiting, due to reassessing the risk of collision. As another example, a simulated behavior of an object may ensure kinematical feasibility by learning from the real-world vehicle behavior. This approach allows learning from real complexity in different types of behaviors, and accordingly allows flexible and realistic simulation results with few parameters defined by a user. Referring again to the earlier example of an aborted merge attempt, a user does not need to provide parameters including, e.g., the timing of the object's deceleration and/or the rate of deceleration—the AI agent system may learn such information from a prior real-life behavior of the vehicle.

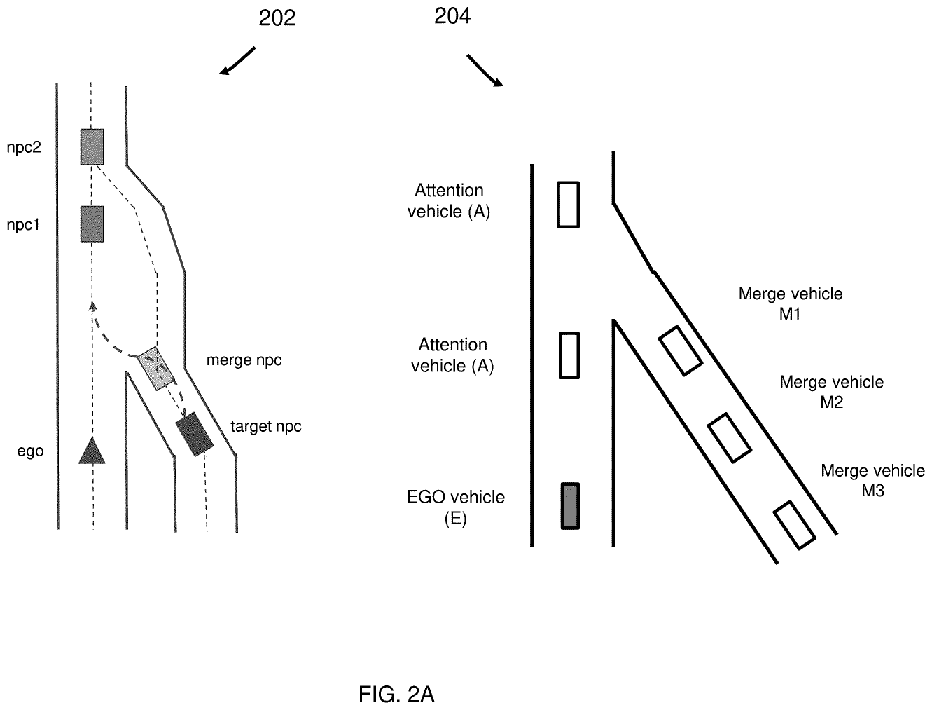

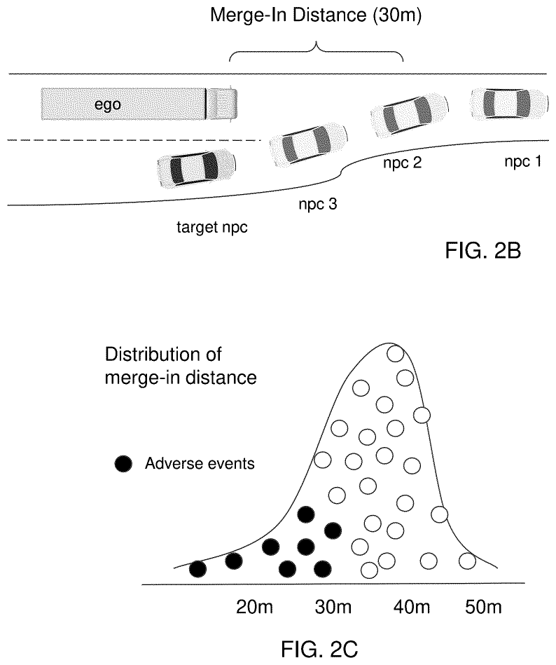

Some behaviors can be unrealistic/dangerous to gather in real life, although they may be desirable in offline evaluation components such as simulation. For example, it may be essentially impossible or prohibitively dangerous to gather data from real life events such as accidents or near-miss scenarios, real-world data may be insufficient to adequately train the autonomous driving system, via the AI agent system, to handle such scenarios. See, e.g., FIG. 2C and relevant description thereof. The AI agent system may allow the creation of specific behaviors/trajectories that can be used along with data gathered in real-life situations to train and/or test an autonomous driving system. Furthermore, the AI agent system can generate a trajectory with a same format as the data gathered in real-life situations, so that the system-generated trajectory can also be fed back into the AI agent system for further processing for the purposes of, e.g., training/learning a specific behavior pattern, using both the real-life data and the system-generated data including, e.g., accident data, to train the autonomous driving system.

Embodiments of the AI agent system and method are described with reference to the scenario of traffic merge for illustration purposes and not intended to be limiting. The AI agent system and method as disclosed herein may be applied to generate simulated behavior of an agent vehicle (also referred to as a nonplayer character (NPC)) in other scenarios including, e.g., following traffic, emergency stop, highway driving, traffic jams, roundabouts, intersections, pedestrian crossing, or the like, or a combination thereof. The AI agent system and method as disclosed herein may be applied to generate simulated behavior of an object other than an agent vehicle including, e.g., a target vehicle (or referred to as ego), a pedestrian, etc. The AI agent system and method as disclosed herein may be applied to generate simulated behavior of an object in a simulated environment for training or testing an autonomous driving system, or for other purposes such as training human drivers, creating video games, creating movies, etc.

FIG. 2A shows example information from a surrounding area of the ego that is used for merge window recommendation. Scenario 202 depicts the case where the ego is traveling on a road (or lane) that merges with another road (or lane). Therefore, the ego has to figure out how to merge with other vehicles. There are two attention vehicles (also referred to as front npc) in front of the ego (npc1, npc2) that the ego vehicle should pay attention to for maintaining a safe gap or following distance. A target npc may be traveling on the road that is merging with the ego vehicle's road.

FIG. 2A shows another example scenario 204 in which there are three merge vehicles M1, M2 and M3. This would mean that the potential candidates for merge window may be four-either in front of M1, or between M1 and M2, or between M2 and M3 or behind M3.

FIG. 2B illustrates another example of a merge scenario according to some embodiments of the present document. Specifically, FIG. 2B depicts the case where the ego is traveling on a road (or lane) that merges with another road (or lane). Therefore, the ego has to figure out how to merge with other vehicles. There is one attention vehicle in front of the ego (npc1) that the ego vehicle should pay attention to for maintaining a safe gap or following distance. There are three npcs, npc 2, npc 3, and target npc, that are merging into the road or lane where the ego is travelling. The merging distance between the ego and npc2 is approximately 30 m. The merging distance between the ego and npc3 is lower than 30 m. The merging distance between the ego and the target npc is also below 30 m, and may be dangerously low such that a collision may occur if the target npc merges into the road in front of the ego.

FIG. 2C illustrates an example of a distribution of merging distances according to some embodiments of the present document. Most merges occur where the merging distances exceed 30 m. A merging distance below 30 m may constitute an adverse case and is relatively rare. However, such cases may be important in the training of an autonomous driving system and may be created by simulation.

To create a simulated environment that depicts a scenario for traffic merge (e.g., scenario 202, scenario 204, or another scenario) for training the autonomous driving system of the ego vehicle, the trajectory of each of one or more npcs needs to be created.

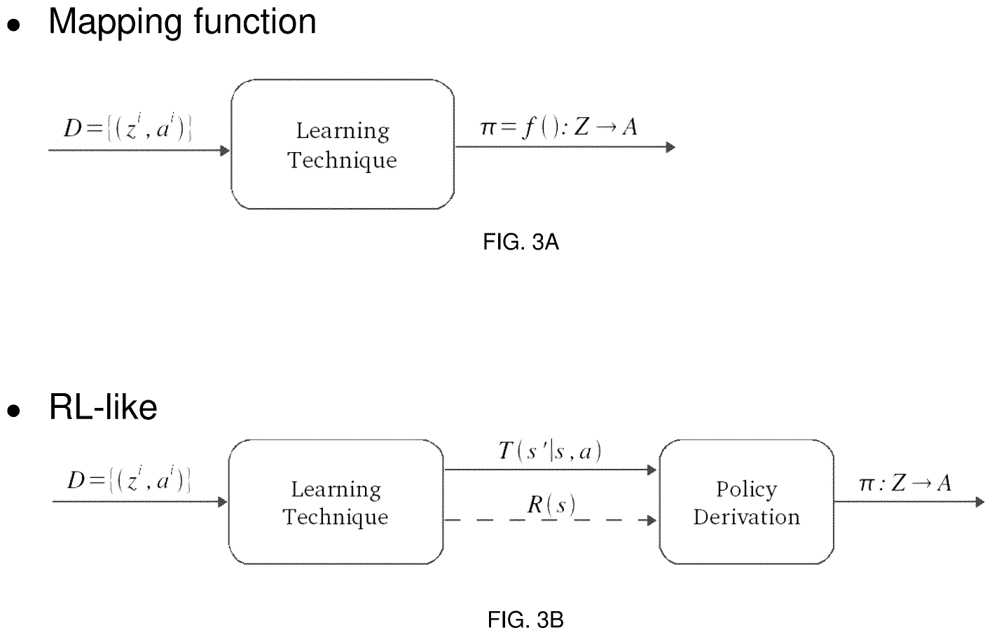

In some embodiments, the behavior simulation (e.g., trajectory simulation) as disclosed herein may be based on a technique of Learning from Demonstration (LfD), in which policies are developed from example state to action mappings. The technique may be implemented in various ways including, e.g., mapping function as illustrated in FIG. 3A and reinforcement learning (RL)-like method as illustrated in FIG. 3B.

As illustrated in FIG. 3A, the mapping function may translate observed demonstrations D into actionable instructions or behaviors A based on a learning technique. D represents a dataset of demonstrations, zᵢ represents the state of state(s) or situation(s) observed during the demonstration, and aᵢ represents the action(s) taken in that state during the demonstration. The learning technique takes the dataset D as input and learns from it. The learning may involve, e.g., extracting patterns, understanding the relationship between actions and states, or fitting a model to the data. Policy derivation is a process of deriving a policy IT from the learned information, which maps states (or observations) Z to actions A. The policy function is the result of the policy derivation process and dictates the agent's behavior.

As illustrated in FIG. 3B, an RL-like function can integrate a reward function R(s) into the learning. D represents a dataset of demonstrations, zᵢ represents the state of state(s) or situation(s) observed during the demonstration, and aᵢ represents the action(s) taken in that state during the demonstration. The learning technique takes the dataset D as input and learns from it. The learning may involve, e.g., extracting patterns, understanding the relationship between actions and states, or fitting a model to the data. T represents a transition function, which defines the probability of transitioning to a new state s′ given a current state s and an action a. Policy derivation is a process of deriving a policy IT from the learned information, which maps states (or observations) Z to actions A. The policy function is the result of the policy derivation process and dictates the agent's behavior.

For illustration purposes and not intended to be limiting, the following description is based on the mapping function. It is understood that the RL-like technique or other technique may be employed.

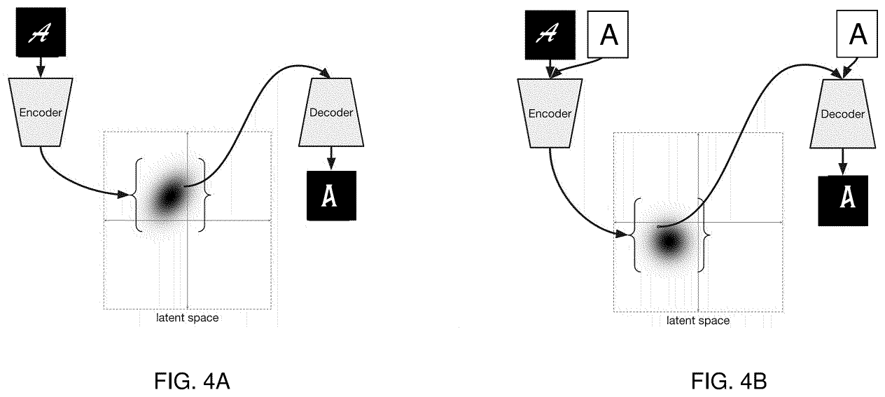

In some embodiments, the behavior simulation as (e.g., trajectory simulation) disclosed herein may involve a Conditional Variational Autoencoder. FIG. 4A illustrates an architecture of a Variational Autoencoder (VAE). FIG. 4B illustrates an architecture of a Conditional Variational Autoencoder (CVAE).

As illustrated in FIG. 4A, the VAE starts with an input, in this case, an image of the letter “A.” This image is the data that the model will learn to encode and reconstruct. The encoder is a neural network that processes the input image and compresses it into a smaller, more dense representation. This process involves reducing the dimensionality of the input data to capture the most salient features. The encoder outputs parameters (mean and variance) that define a probability distribution in the latent space. The encoder's output is a point in the “latent space,” which is a compressed representation of the input data. In a VAE, this space is treated probabilistically such that the encoder outputs parameters that define a distribution over the latent space from which a sample is drawn. This probabilistic approach allows the model to generate new data that is similar to the input data. The decoder is also a neural network that takes the sampled point from the latent space and reconstructs the input data. The goal of the decoder is to generate an output that is as close as possible to the original input, effectively learning the distribution of the input data. The output is the reconstructed image, which the VAE aims to make indistinguishable from the original input. The quality of the reconstruction can be a measure of how well the VAE has learned to model the input data.

A CVAE may be considered an extension of the VAE that incorporates conditional variables into the model, allowing it to generate outputs based on specified conditions, the label A provided as input, along with the image of the letter “A,” to the encoder as illustrated in FIG. 4B. The CVAE allows for the generation of data that is not only varied but also conforms to specified conditions, making it a powerful tool for tasks where control over certain aspects of the generated output is desirable.

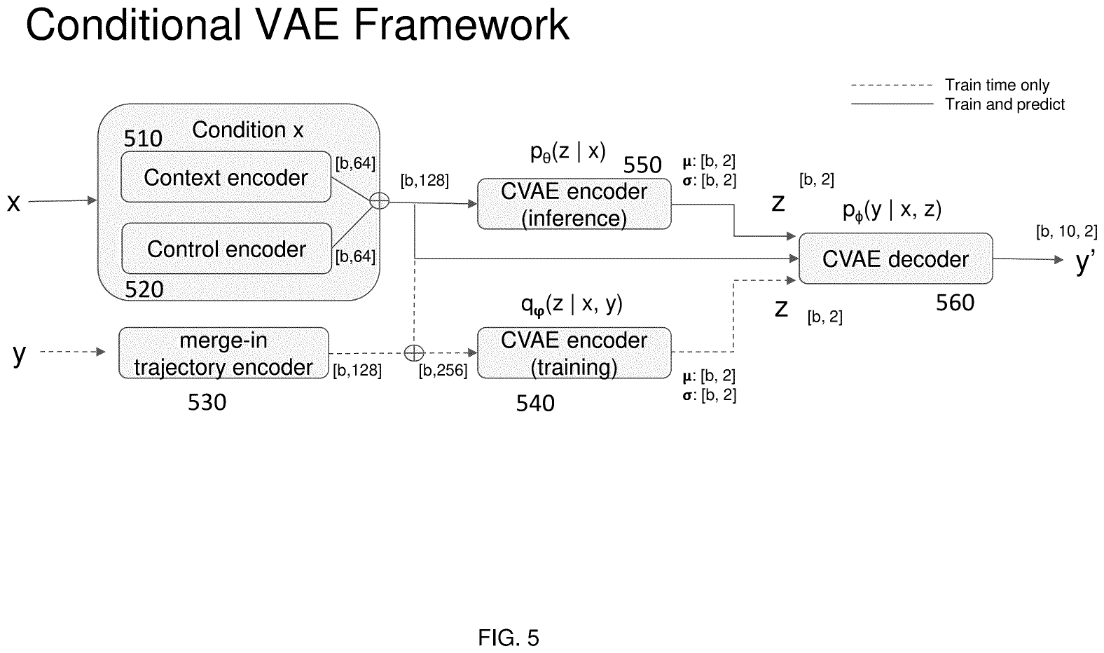

FIG. 5 illustrates a CVAE framework for behavior simulation (e.g., trajectory simulation) in traffic merge according to some embodiments of the present document. The illustrated architecture shows the CVAE framework during both the training phase (dashed lines with arrows) and the application or inference phase (solid lines with arrows). There are two inputs to the system: x, which goes into the Condition, and y, which illustrates ground truth and is used only during training and goes into the merge-in trajectory encoder. The inputs x and y are processed by different encoders.

Condition x includes conditional information. In a trajectory simulation with respect to an object (e.g., an agent vehicle), x may include context information and control information. The context information may include information describing an environment of the object. In some embodiments, the context information includes at least one of traffic information and map information.

The traffic information may include information relating to a merge by the object from a ramp or from an adjacent lane or information of neighboring objects in a vicinity of the object. With reference to scenario 202 illustrated in FIG. 2A, example traffic information may include information relating to merge npcs, including a target npc (or referred to as a target agent or target agent vehicle) whose trajectory is to be simulated, front npcs (e.g., npc1, npc2), ego, or the like, or a combination thereof. The traffic information may be dynamic with respect to a specific occurrence of a traffic merge. For example, the traffic information may include information at a current time point, information regarding a time point or a time period before the current time point (history) or after the current time point (future) that are relevant to a specific occurrence of a traffic merge. Merely by way of example, the traffic information may include history and/or future information of the ego.

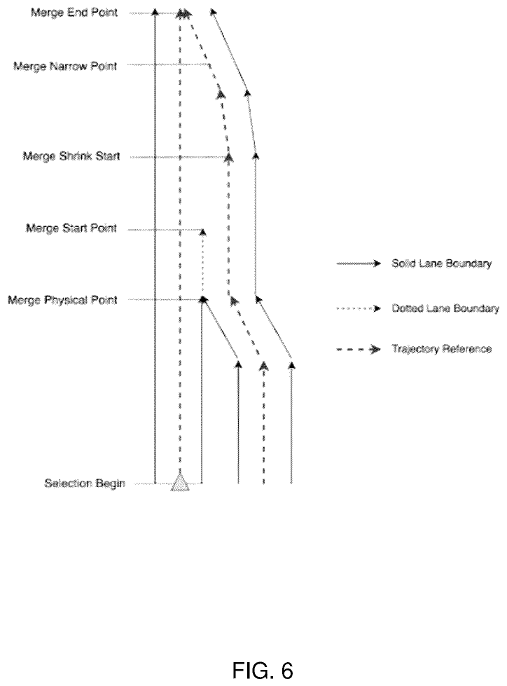

The map information may be static with respect to a specific occurrence of a traffic merge. The map information may include a merge structure. The merge structure may include information describing boundaries where a merge occurs. The boundaries may include or relate to the dimensions or constraints of the roads or lanes involved in a traffic merge including, e.g., a main road where a merge npc is to enter, a ramp or an adjacent lane where the merge npc exits, a divider between the main road and the ramp or adjacent lane, a road or lane block or closure (due to, e.g., construction, an accident, a public event, a natural obstruction (such as a fallen tree, landslide, flood)), etc. Merge key points may be determined based on the merge structure, as well as the operation parameters (e.g., speed, position, acceleration, etc.) of the vehicles involved including the ego, one or more merge npcs, attention npcs, or the like, or a combination thereof. The merge structure and the merge feature points illustrated in FIG. 6 correspond to scenario 202 illustrated in FIG. 2A. Example merge key points may include a merge end point, a merge narrow point, a merge shrink point, a merge start point, a merge physical point, and a starting point at which selection of a merge window begins.

The control information may include information relating the operation or behavior of the object. Example control information may include a merging distance (also referred to as a merge-in distance, a merge gap), aggressiveness of the object (e.g., acceleration, deceleration, jerkiness, smoothness, or the like, or a change thereof), or the like, or a combination thereof.

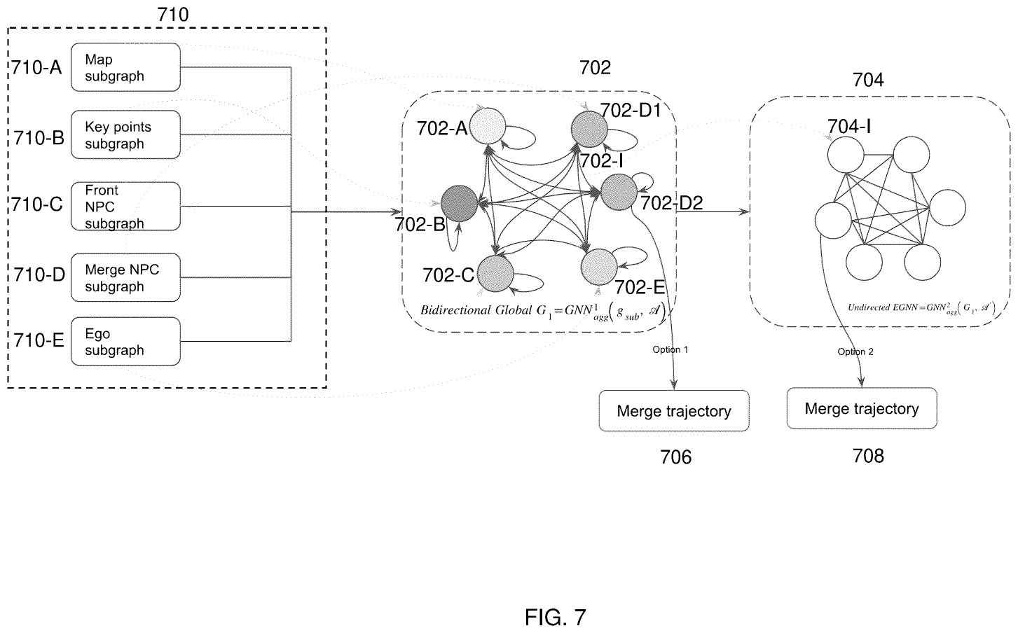

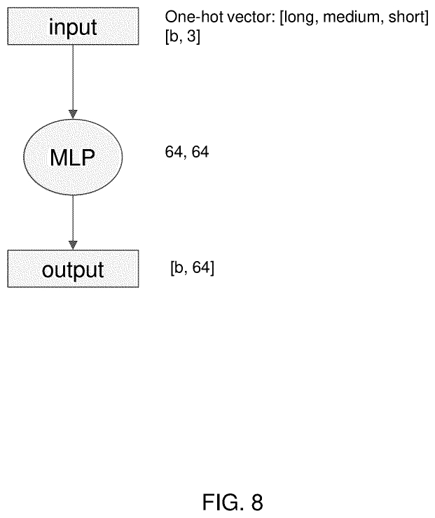

As illustrated in FIG. 5, the condition x may be processed in two different ways to capture different aspects of the input data x. The context information may be processed using the context encoder 510 (see, e.g., FIG. 7) to generate a context feature representation. The control information may be processed using the control encoder 520 (see, e.g., FIG. 8) to generate a control feature representation. A bracket, such as [b,64], indicate the size of the output tensor from an encoder or decoder (e.g., the context encoder 510, the control encoder 520, the merge-in trajectory encoder 530, the CVAE encoder 540/550, the CVAE decoder 560), where b is the batch size, and the second number, such as 64 in the example of [b,64], represents the dimensionality of the encoded representation. More description of the context encoder 510 and the control encoder 520 may be found elsewhere in the present document. See, e.g., FIG. 8 and the description thereof.

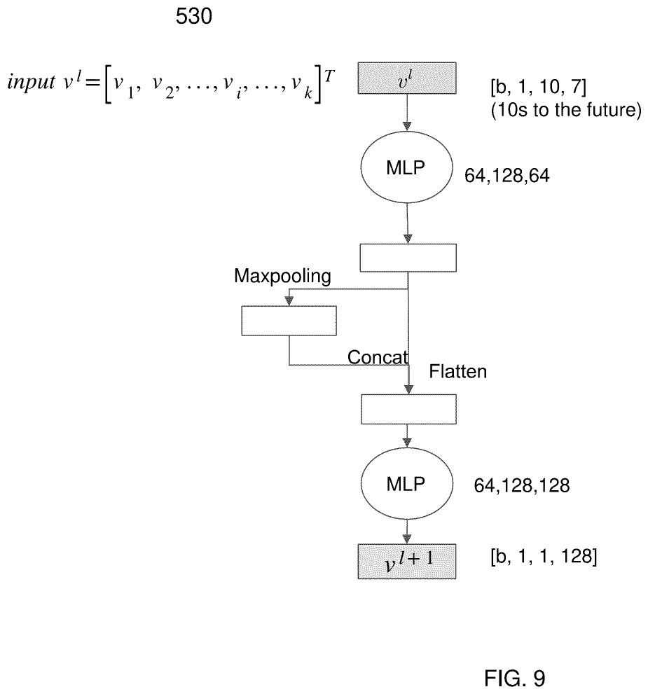

The merge-in trajectory encoder 530 takes y as an input during training to learn the relationship between y (e.g., the ground truth) and x. x and y may be real-world data gathered during a road trip, e.g., a test drive of the ego or another vehicle. More description of the merge-in trajectory encoder 530 may be found elsewhere in the present document. See, e.g., FIG. 9 and the description thereof.

During training, the outputs of the encoders (including the context encoder 510, the control encoder 520, and the merge-in trajectory encoder 530) are combined and further processed using the CVAE encoder 540 to determine a probability distribution in the latent space. The distribution may be characterized by a mean u and a standard deviation σ. The CVAE encoder 540 uses both x and y to determine latent space distribution parameters, denoted as qφ(z|x,y).

The latent space Z is where the encoder 540 learns a compressed representation of the input data, conditioned on x (and y during training). The representation is probabilistic, with the mean u and the standard deviation σ defining the parameters of the distribution from which the latent variables are sampled.

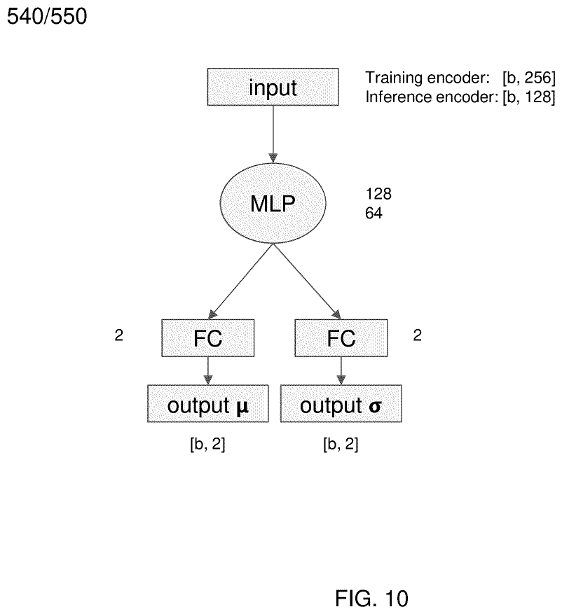

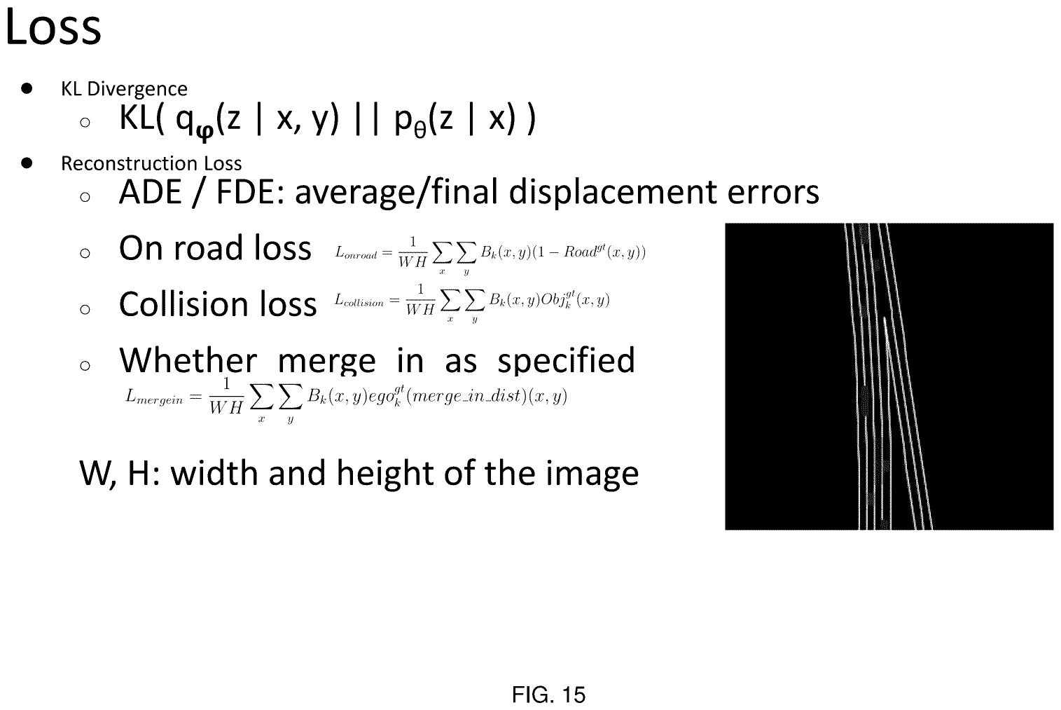

The training of the CVAE encoder 540 may be evaluated based on a loss function, which is described elsewhere in the present document. See, e.g., FIG. 15 and relevant description thereof. When the CVAE encoder 540 is deemed sufficiently trained, it may be applied to generate a simulated trajectory of an object based on condition x. For convenience, the CVAE encoder 540, when trained, is denoted as the CVAE encoder 550. More description of the CVAE encoder 540/550 may be found elsewhere in the present document. See, e.g., FIG. 10 and the description thereof. The CVAE encoder 540 and the CVAE encoder 550 may also be termed as an input encoder configured to receive input x on the basis of which y is generated. The input encoder may be based on a model different than a CVAE model.

In the application phase (or referred to as inference phase), the CVAE encoder 550 uses only condition x (and does not need y as input) to determine the latent space distribution parameters, denoted as pθ(z|x,y).

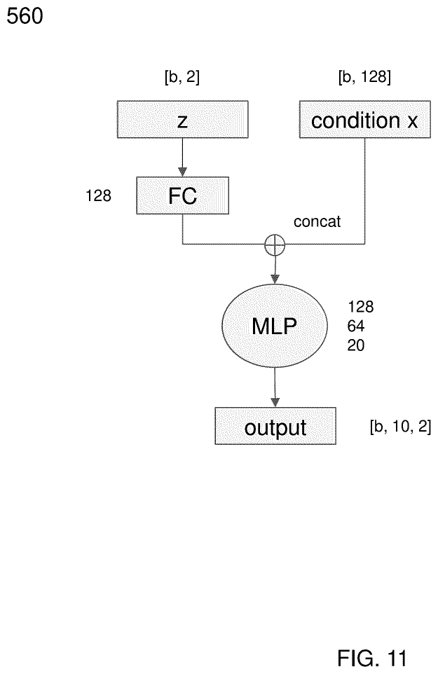

The CVAE decoder 560 takes the sampled z and the condition x to reconstruct the output y′, a prediction or reconstruction of y based on the latent representation and the given condition x. During the application (or inference) phase, y′ is the final product that is the reconstructed or generated data based on the input x and the learned latent representation z. More description of the CVAE decoder 560 may be found elsewhere in the present document. See, e.g., FIG. 11 and the description thereof. During the training phase, the model is trained by adjusting the parameters of the CVAE encoder 540 and the CVAE decoder 560 to reduce or minimize a difference between the ground truth y and the predicted y′, and to regularize the latent space to follow a specified distribution (e.g., a Gaussian distribution). This may be achieved using a combination of reconstruction loss and a divergence measure such as, e.g., the Kullback-Leibler (KL) divergence. See, e.g., FIG. 15 and relevant description thereof.

It is understood the CVAE framework illustrated in FIG. 5 is described in the context of behavior simulation (e.g., trajectory simulation) in the context of a traffic merge for illustration purposes and not intended to be limiting. The CVAE framework as illustrated may be applied in simulation in another context.

FIG. 7 depicts an example of a context encoder according to some embodiments of the present disclosure. FIG. 7 shows a conceptual diagram of how input information 710 that corresponds to input condition x relating to a traffic merge represents nodes of a connected graph neural network (GNN). The input information 710 may be presented as subgraphs (an exemplary format of feature representation). The input information 710 may include map subgraph 710-A, key points subgraph 710-B, front npc subgraph 710-C, merge NPC subgraph 710-D, and ego subgraph 710-E. A subgraph may include information of a plurality of entities of a same category. For example, the key points subgraph 710-B may include information of multiple key points of a traffic merge. As another example, the front NPC subgraph 710-C may include information of multiple front npcs (e.g., npc1 and npc2 in scenario 202 as illustrated in FIG. 2A, two attention vehicles in scenario 204 as illustrated in FIG. 2A). As a further example, the merge NPC subgraph 710-D may include information of multiple merge npcs (e.g., merge npc and target npc in scenario 202 as illustrated in FIG. 2A, M1-M3 in scenario 204 as illustrated in FIG. 2A). A global graph 702 may be obtained from the input information 710. Each node of the global graph 702 may correspond to an agent (e.g., ego vehicle, merge npc, or attention npc), map, or key points. For example, node 702-A may correspond to map as represented in map subgraph 710-A. As another example, node 70B-A may correspond to the key points as represented in key points subgraph 710-B. As a further example, node 702-C may correspond to a front npc as represented in front NPC subgraph 710-C. As still a further example, nodes 702-D1 and 702-D2 may correspond to two merge npcs as represented in merge npc subgraph 710-D. As still a further example, node 702-E may correspond to an ego vehicle as represented in ego subgraph 710-E. Using the edge information of the global graph 702, the GNN of the global graph 702 may be converted into a hypergraph 704. In the hypergraph 704, some nodes (e.g., node 704-1) represent the edges (e.g., edge 702-1) between nodes of the GNN 702 that represent possible merge windows where an agent vehicle may merge into the road or lane where the ego is operating. With reference to this example of a traffic merge, in some embodiments, a merge trajectory 706 of a merge npc may be determined using the encoding of the node corresponding to the target npc (702-D2) as illustrated in the global graph 702 (option 1 in which the context encoder is configured to encode the input information 710 and output the latent space features in the form of the global graph 702 with an encoding side of [batch_size b, 64]); in some embodiments, a merge trajectory 708 of a merge npc may be determined using the encoding of an edge between the ego vehicle and a front npc in the hypergraph 704 (option 2, in which the context encoder is configured to encode the input information 710, generate an intermediate result of the global graph 702, and output the latent space features in the form of the hypergraph 704 with an the encoding size may be [batch_size b, 64]). In some embodiments, the feature representation of input condition x input to the GNN 702 may take the form of a feature vector. The context encoder may include a neural network architecture other than GNN.

FIG. 8 depicts an example of a distance encoder according to some embodiments of the present disclosure. As illustrated, the distance encoder 520A includes a neural network architecture, specifically a Multi-Layer Perceptron (MLP). The neural network includes an input layer, some hidden layers, and an output layer. The input includes a vectorized representation of a merging distance using parameters [b, 3] representing a vector. Here, “b” represents the batch size, and “3” represents the feature dimension. The merging distance may be a categorical variable (e.g., high, medium, low) represented using a one-hot vector. “MLP” represents the hidden layers of the neural network. As illustrated, the MLP includes two hidden layers, each with 64 units/neurons. The MLP may include fully connected layers, which means each neuron in one layer is connected to all neurons in a next layer. The output layer of the network is characterized by [b, 64], suggesting that the network outputs a batch of ‘b’ examples, each with 64 features. The distance encoder 520 is provided as an example of the control encoder 520 for illustration purposes and not intended to be limiting. The control information may include a merging distance and one or more other parameters including, e.g., aggressiveness. Aggressiveness may be described using acceleration, deceleration, etc. The control information may be encoded using the control encoder 520.

FIG. 9 depicts an example of a merge-in trajectory encoder according to some embodiments of the present disclosure. The encoding scheme may be used for generating a vectorized representation of a merge-in trajectory. As illustrated, the vectorized representation may use parameters [b, 1, 10, 7] representing a vector. Here, “b” represents the batch size, “1” represents the number of target npcs with respect to which a merge trajectory is to be generated (here, 1 target npc), “10” represents the number of frames used for the encoding, and “7” represents the feature dimension of the object. The encoding structure represents a PointNet like encoder neural network in which successive stages of MLP, maxpooling, and concatenation with output of maxpooling, and layer normalization (blank boxes) are operated to produce higher feature dimension vector outputs of the encoding (in this specific example, [b, 1, 1, 128]).

FIG. 10 depicts an example of a CVAE encoder according to some embodiments of the present disclosure. As illustrated, the CVAE encoder includes a neural network architecture, specifically a Multi-Layer Perceptron (MLP). The neural network includes an input layer, some hidden layers, and an output layer. The input may include a feature representation that corresponds to input condition x. The feature representation may be a feature vector. As discussed with reference to FIG. 5, in the training phase, the input to the CVAE encoder 540 (also referred to as training encoder) may include condition x and also ground truth y, and correspondingly a vector characterized by [b, 256] with a feature dimension of 256; in the application phase, the input to the CVAE encoder 550 (also referred to as training encoder) may include condition x but not ground truth y, and correspondingly a vector characterized by [b, 128] with a feature dimension of 128.

The MLP is the encoder part of a CVAE framework. The MLP is configured to encode the vectorized feature that corresponds to input condition x (and also the ground truth y in the training phase) to a latent space. As illustrated, the MLP has two layers, with the first layer having 128 neurons and the second layer having 64 neurons. The MLP is connected to two separate outputs, output u representing the mean of the latent variables, and output σ representing the standard deviation or variance of the latent variables. As illustrated, each of the two outputs is a 2-dimensional vector for each of ‘b’ examples in the batch. “FC” stands for a fully connected layer, indicating that each neuron in one layer of the MLP is connected to all neurons in a next layer of the MLP.

FIG. 11 depicts an example of a CVAE decoder according to some embodiments of the present disclosure. A latent variable z has a batch size ‘b’ and 2 features. Condition x that corresponds to the latent variable also have a batch size “b” but 128 features. Through the FC layer with 128 neurons, the latent variable z is mapped to a higher-dimensional space, which is concatenated with condition x into a single tensor. The concatenated tensor is fed into an MLP, which is configured to transform the combined latent variable and condition into output data. As illustrated, the MLP has three layers with 128, 64, and 20 neurons, respectively. The output of the MLP may include ‘b’ examples, and each of the ‘b’ examples in the batch, the network outputs a 10×2 matrix. This may represent 10 separate features each with 2 dimensions, or some other structured output appropriate for the specific application of the CVAE.

It is understood that encoders and decoder in FIGS. 7-11 are shown to include an MLP architecture for illustration purposes and not intended to be limiting. Other neural network architecture may be used in constructing an encoder or decoder disclosed herein.

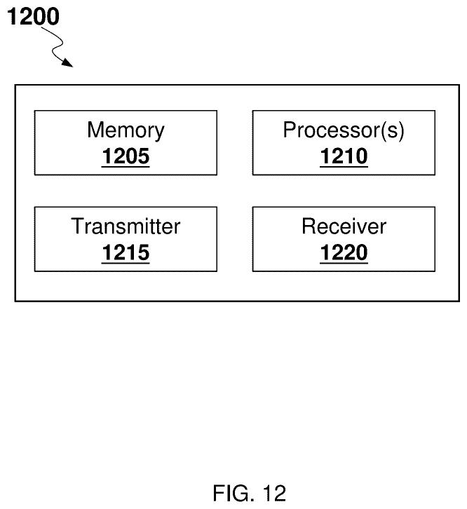

FIG. 12 illustrates an example of a hardware platform that can implement some methods and techniques described in the present document. The system 1200 may include memory 1205 and processor(s) 1210. The memory 1205 may have instructions stored thereupon. The instructions, upon execution by the processor(s) 1210, may configure the system 1200 (e.g., the various modules of the system 1200) to perform the operations described elsewhere in the present document including, e.g., those illustrated in FIGS. 4A, 4B, 5, 7-11, and/or 13-15. The processor(s) 1210 may include at least one graphics processing unit (GPU).

In some embodiments, the system 1200 may include a transmitter 1215 and a receiver 1220 configured to send and receive information, respectively. At least one of the transmitter 1215 or the receiver 1220 may facilitate communication via a wired connection and/or a wireless connection between the system 1200 and a device or information resource external to the system 1200. For instance, the system 1200 may receive runtime data acquired by various components of an autonomous vehicle during an operation of the vehicle via the receiver 1220. As another example, the system 1200 may receive input from a user via the receiver 1220. As a further example, the system 1200 may transmit a notification to a user (e.g., an autonomous vehicle, a display device) via the transmitter 1215. In some embodiments, the transmitter 1215 and the receiver 1220 may be integrated into one communication device.

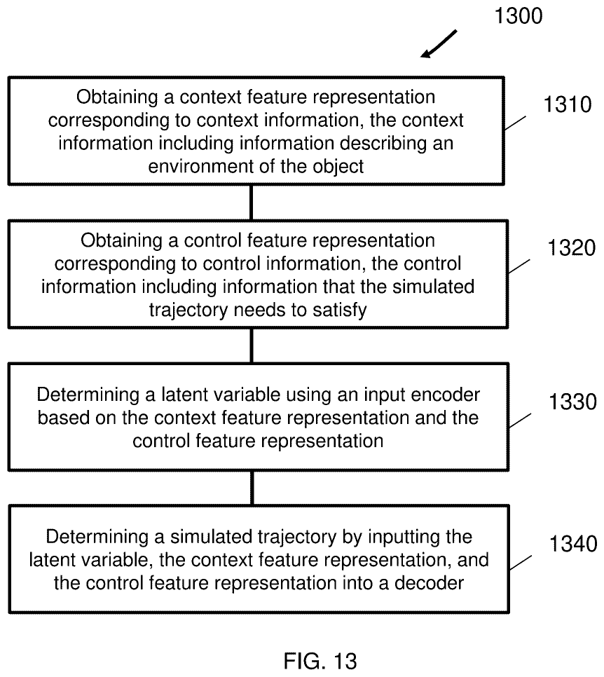

FIG. 13 illustrates a flowchart of a process 1300 for simulating a trajectory of an object according to some embodiments of the present document. At 1310, at least one processor (e.g., the autonomous driving simulation system 180 as illustrated in FIG. 1, an AI agent system of the autonomous driving simulation system 180, one or more of the processor as illustrated in FIG. 12) may obtain a context feature representation corresponding to context information. The context information may include information describing an environment of the object. The context feature representation may take the form of a feature vector, subgraphs, or the like, or a combination thereof. More description of the context information and context feature representation may be found elsewhere in the present document. See, e.g., FIGS. 5 and 7, and relevant description thereof. In some embodiments, the at least one processor may apply the context information into a context encoder (e.g., 510 as illustrated in FIGS. 5 and 7) to generate the context feature representation.

At 1320, the at least one processor may obtain a control feature representation corresponding to control information. The control information may include information that the simulated trajectory needs to satisfy. The control feature representation may take the form of a feature vector, subgraphs, or the like, or a combination thereof. More description of the control information and control feature representation may be found elsewhere in the present document. See, e.g., FIGS. 5 and 7, and relevant description thereof. In some embodiments, the at least one processor may apply the control information into a control encoder (e.g., 520 and 520A as illustrated in FIGS. 5 and 8, respectively) to generate the control feature representation.

The context information and/or the control information may be specified to create a simulated trajectory corresponding to a desired scenario. For example, a merging distance may be specified to create a simulated trajectory mimicking a specific merge scenario (e.g., a merge scenario with a dangerously small merging distance). The merging distance may be one from a continuous range, or one that corresponds to a category (e.g., high, medium, low).

At 1330, the at least one processor may determine a latent variable using an input encoder (e.g., the CVAE encoder 550 as illustrated in FIGS. 5 and 10) based on the context feature representation and the control feature representation. For example, the at least one processor may obtain a concatenated feature vector by concatenating the context feature vector and the control feature vector; and input the concatenated feature vector to the input encoder to determine the latent variable.

At 1340, the at least one processor may determine a simulated trajectory by inputting the latent variable, the context feature representation, and the control feature representation into a decoder. The simulated trajectory may satisfy a control, e.g., a condition corresponding to at least a portion of the control information and/or the context information. For example, the simulated trajectory stays within a merge structure specified in the context information, does not collide with another agent or an ego vehicle, does not exceed a road or lane boundary, and/or does not bump into a road block before, during, and/or after the traffic merge corresponding to the simulated trajectory. As another example, the simulated trajectory may reflect a varying speed of the object, mimicking a real-world scenario in which the object adjusts its speed in response to the behavior of another object (e.g., an ego vehicle, another npc) in the vicinity of the object.

In some embodiments, the at least one processor may create a simulated environment including one or more objects (e.g., an ego vehicle, one or more npcs). See, e.g., the environment as illustrated in FIG. 2A. The at least one processor may generate a simulated trajectory for each of one or more objects to create the simulated environment. The at least one processor may generate using a same technique or different techniques to generate the simulated trajectories. For example, for a first npc with a merging distance with respect to the ego that exceeds a threshold, the at least one processor may generate a first simulated trajectory using a rule-based technique, and for a second npc with a merging distance with respect to the ego that is below the threshold, the at least one processor may generate a second simulated trajectory using an AI based simulation technique as disclosed herein.

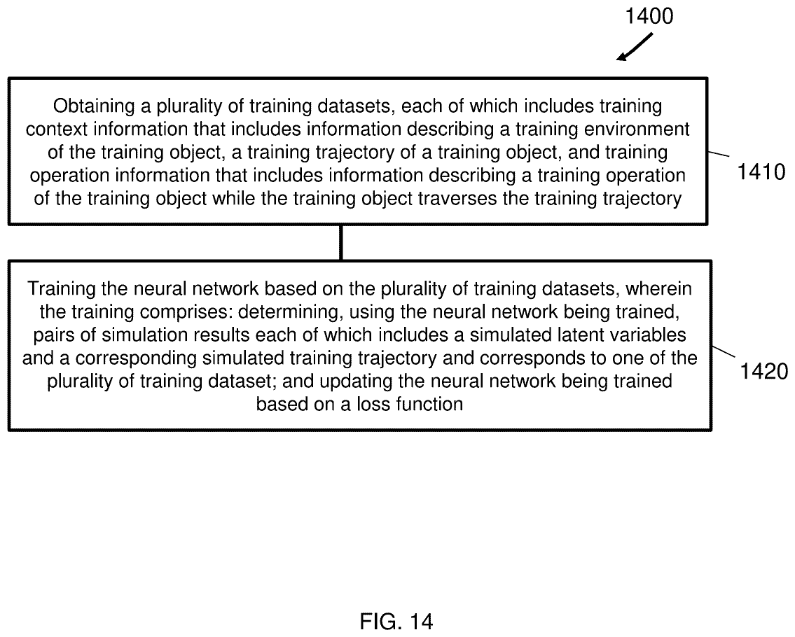

FIG. 14 illustrates a flowchart of a process 1400 for training a neural network configured to simulate a trajectory of an object according to some embodiments of the present document. At 1410, at least one processor may obtain a plurality of training datasets. A training dataset may include training context information that includes information describing a training environment of the training object, a training trajectory of a training object, and training operation information that includes information describing a training operation of the training object while the training object traverses the training trajectory. At least a portion of the training datasets may be gathered from real-world road trips of one or more vehicles. In some embodiments, a portion of the training datasets may be synthesized based on data gathered from real-world road trips of one or more vehicles. For example, based on data from a road trip of a test vehicle, a new trajectory may be generated based on the actual trajectory of the vehicle during the road trip by modifying the actual acceleration (e.g., increasing the acceleration) of the test vehicle (corresponding to an increased engine torque output) within the limit of the mechanical capacity of the test vehicle. This allows simulation of scenarios that are rarely seen and/or dangerous in real world but important in the training of an autonomous driving system.

At 1420, the at least one processor may train the neural network based on the plurality of training datasets. The training may include determining, using the neural network being trained, pairs of simulation results. A pair of the simulation results may correspond to one of the plurality of training dataset and include a simulated latent variables and a corresponding simulated training trajectory. The training may further include updating the neural network being trained based on a loss function. FIG. 15 illustrates an example of the loss function. The training may proceed until a training condition is satisfied. In some embodiments, the training condition may relate to the loss function.

In some embodiments, the neural network may include an encoder (e.g., the CVAE encoder 540/550 as illustrated in FIGS. 5 and 10) and a decoder (e.g., the CVAE decoder 560 as illustrated in FIGS. 5 and 11). The encoder and the decoder may be trained simultaneously. In some embodiments, the training may proceed iteratively in which one round of training is performed based on one training dataset. In some embodiments, the training may proceed following a strategy other than iterative training. Example strategies may include batch training, transfer learning, federated learning, etc. Under the strategy of batch training, multiple training datasets may be combined into one large batch so that the network can be trained on this combined dataset. Under the strategy of transfer learning, a network may be first trained on one training dataset (e.g., a combined dataset which is large and diverse) and then fine-tuned with other training datasets. Under the strategy of federated learning, training datasets may be decentralized due to, e.g., privacy or logistical reasons; a network can be trained across multiple nodes, each holding different datasets, and the model may learn locally and only share updated parameters or gradients, not the data itself.

FIG. 15 depicts an example of a loss function according to some embodiments of the present disclosure. The loss function of the network training as illustrated in FIG. 14 may include a portion relating to a divergence measure in the latent space and a portion relating to a reconstruction loss. The divergence may be measured according to, e.g., the Kullback-Leibler (KL) divergence. With reference to the example illustrated in FIG. 5, the divergence may be measured according to the following formula:

$$KL ( {q}_{φ} ( z \vert x , y ) ‖ {p}_{θ} ( z \vert x ) ) . \qquad ( 1 )$$

Formular (1) measures a difference between the distribution p_{θ}(z|x)) of the latent variables corresponding to the simulation results of the CVAE encoder 540 and the distribution q_{φ}(z|x,y) of the latent variables corresponding to the ground truths (e.g., real-world data).

The reconstruction loss may be measured by one or more of the following terms including: average/final displacement errors (ADE/FDE), on road loss, collision loss, loss assessing whether a merge can occur as specified. The average displacement error of a merge event (simulated or the corresponding ground truth) may assess a deviation of the simulated trajectory from the corresponding ground truth averaged over the time window of the merge event (e.g., the time window between the selection begin and the merge end point as illustrated in FIG. 6). The final displacement error may assess the deviation of the simulated trajectory and the ground truth at the end of the merge event (e.g., at the merge end point as illustrated in FIG. 6). The on road loss may assess whether the simulated trajectory stay within the road boundary and/or the merge structure. The collision loss may assess whether a collision may occur if the simulated trajectory is followed. The loss assessing whether a merge can occur as specified may indicate whether a merge may occur as specified (e.g., a merge is completed at a specified merging distance) if the simulated trajectory is followed. A simulated trajectory may take the form of a vector; the vector may be converted to an image so that the loss may be assessed in the image space, instead of the vector space.

The sufficiency of a network training or performance of the trained network may be evaluated based on metrics at the trajectory level (reflecting reconstruction loss) and/or the distribution level (reflecting a distribution of generated trajectories). Merely by way of example, at the trajectory level, a collision rate may be determined to be the ratio of the number (or count) of trajectories having collisions to the number (or count) of sample trajectories; the evaluation at this level may be deemed satisfied if a ratio of the number (or count) of satisfactory trajectories to the number (or count) of sample trajectories is below a threshold. At the distribution level, for each merging distance, the evaluation is performed by assessing a distribution of real trajectories (ground truths) relative to generated or simulated trajectories sampled from the same contexts (e.g., same input condition x as discussed with respect to FIG. 5) and a specified merging distance requirement; the evaluation at this level may be deemed satisfied if the generated merge trajectories for different merging distances may have a distribution sufficiently similar to the real world distribution (of ground truth trajectories for such different merging distances as exemplified in FIG. 2C). It is understood that evaluations at the trajectory level or distribution level are different metrics with different focus and that a satisfactory network may have sufficiently good performance on both metrics.

During a training phase (e.g., as discussed with reference to FIG. 14), a neural network may be trained by adjusting the parameters of the network to reduce or minimize the reconstruction loss, and to regularize the latent space to follow a specified distribution (e.g., a Gaussian distribution).

Some example technical solutions adopted by preferred embodiments are implemented as described below.

A method for simulating a trajectory of an object, comprising: obtaining a context feature representation corresponding to context information, wherein the context information comprises information describing an environment of the object; obtaining a control feature representation corresponding to control information, wherein the control information comprises information that the simulated trajectory needs to satisfy; determining a latent variable using an input encoder based on the context feature representation and the control feature representation; and determining the simulated trajectory by inputting the latent variable, the context feature representation, and the control feature representation into a decoder.

2. The method of any one or more of the solutions disclosed herein, in which obtaining the context feature representation comprises applying the context information into a context encoder.

3. The method of any one or more of the solutions disclosed herein, in which obtaining the control feature representation comprises applying the control information into a control encoder.

4. The method of any one or more of the solutions disclosed herein, further comprising: obtaining a concatenated feature representation by concatenating the context feature representation and the control feature representation; and inputting the concatenated feature representation to the input encoder to determine the latent variable.

5. The method of any one or more of the solutions disclosed herein, in which the context information includes at least one of map information and traffic information.

6. The method of any one or more of the solutions disclosed herein, wherein the traffic information including at least one of information relating to a traffic merge by the object from a ramp or from an adjacent lane or information of neighboring objects in a vicinity of the object.

7. The method of any one or more of the solutions disclosed herein, wherein the map information includes a merge structure of the traffic merge or key points of the merge structure.

8. The method of any one or more of the solutions disclosed herein, wherein the control information includes at least one of a merging distance or aggressiveness of the object.

9. The method of any one or more of the solutions disclosed herein, further comprising determining the merging distance from a continuous distance range.

10. The method of any one or more of the solutions disclosed herein, further comprising determining the merging distance from a plurality of categories.

11. The method of any one or more of the solutions disclosed herein, wherein the input encoder and the decoder constitute a neural network trained based on balanced training datasets that correspond to various traffic scenarios.

12. A method for training a neural network configured to simulate a trajectory of an object, the method comprising: obtaining a plurality of training datasets, each of which includes training context information that includes information describing a training environment of the training object, a training trajectory of a training object, and training operation information that includes information describing a training operation of the training object while the training object traverses the training trajectory, training the neural network based on the plurality of training datasets, wherein the training comprises: determining, using the neural network being trained, pairs of simulation results each of which includes a simulated latent variable and a corresponding simulated training trajectory and corresponds to one of the plurality of training dataset; and updating the neural network being trained based on a loss function relating to: (a) a difference between a distribution of the simulated latent variables and a distribution of latent variables corresponding to the training trajectories, and (b) a reconstruction loss relating to differences between the simulated training trajectories and corresponding training trajectories.

13. The method of any one or more of the solutions disclosed herein, in which the plurality of training datasets correspond to various traffic scenarios and are balanced such that respective counts of the various traffic scenarios are in a same order.

14. A method for simulating an environment comprising a plurality of objects, the method comprising: for each of at least one of the plurality of objects, generating a simulated trajectory according to the method of any one or more of the solutions disclosed herein.

15. The method of any one or more of the solutions disclosed herein, further comprising: generating a simulated trajectory according to a pre-determined rule corresponding to a behavior of the object.

16. A system for simulating a trajectory of an object, comprising: memory storing computer program instructions; and one or more processors configured to execute the computer program instructions to effectuate the method of one or more of the examples herein.

17. The system of any one or more of the solutions disclosed herein, further comprising a training module configured to train a neural network according to any one or more of the solutions disclosed herein.

18. A system for simulating an environment comprising a plurality of objects, the system comprising: memory storing computer program instructions; and one or more processors configured to execute the computer program instructions to effectuate the method of any one or more of the solutions disclosed herein.

19. One or more non-transitory computer-readable storage media having code stored thereupon, the code, upon execution by at least one processor causing the at least one processor to implement the method of any one or more of the solutions disclosed herein.

20. The method, system, or one or more non-transitory computer-readable storage media of any one or more of the solutions disclosed herein, in which the neural network includes a conditional variational autoencoder (CVAE).

21. The method, system, or one or more non-transitory computer-readable storage media of any one or more of the solutions disclosed herein, in which at least one of the input encoder or the decoder includes a graph neural network (GNN).

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments. Only a few implementations and examples are described, and other implementations, enhancements and variations can be made based on what is described and illustrated in this patent document.

What is claimed is:

1. A method for simulating a trajectory of an object, comprising:
obtaining a context feature representation corresponding to context information, wherein the context information comprises information describing an environment of the object;
obtaining a control feature representation corresponding to control information, wherein the control information comprises information that the simulated trajectory needs to satisfy;
determining a latent variable using an input encoder based on the context feature representation and the control feature representation; and
determining the simulated trajectory by inputting the latent variable, the context feature representation, and the control feature representation into a decoder.

2. The method of claim 1, wherein obtaining the context feature representation comprises applying the context information into a context encoder.

3. The method of claim 1, wherein obtaining the control feature representation comprises applying the control information into a control encoder.

4. The method of claim 1, further comprising:
obtaining a concatenated feature representation by concatenating the context feature representation and the control feature representation; and
inputting the concatenated feature representation to the input encoder to determine the latent variable.

5. The method of claim 1, wherein the context information includes at least one of map information and traffic information.

6. The method of claim 5, wherein the traffic information including at least one of information relating to a traffic merge by the object from a ramp or from an adjacent lane or information of neighboring objects in a vicinity of the object.

7. The method of claim 6, wherein the map information includes a merge structure of the traffic merge or key points of the merge structure.

8. The method of claim 1, wherein the control information includes at least one of a merging distance or aggressiveness of the object.

9. The method of claim 8, further comprising determining the merging distance from a continuous distance range.

10. The method of claim 8, further comprising determining the merging distance from a plurality of categories.

11. The method of claim 1, wherein the input encoder and the decoder constitute a neural network trained based on training datasets that correspond to various traffic scenarios.

12. The method of claim 11, wherein the neural network includes a conditional variational autoencoder (CVAE).

13. The method of claim 1, wherein at least one of the input encoder or the decoder includes a graph neural network (GNN).

14. The method of claim 1, wherein the environment comprises at least one other object.

15. The method of claim 14, further comprising:
generating a simulated trajectory according to a pre-determined rule corresponding to a behavior of the at least one other object.

16. A method for training a neural network configured to simulate a trajectory of an object, the method comprising:
obtaining a plurality of training datasets, each of which includes training context information that includes information describing a training environment of the training object, a training trajectory of a training object, and training operation information that includes information describing a training operation of the training object while the training object traverses the training trajectory,
training the neural network based on the plurality of training datasets, wherein the training comprises:
determining, using the neural network being trained, pairs of simulation results each of which includes a simulated latent variable and a corresponding simulated training trajectory and corresponds to one of the plurality of training dataset; and
updating the neural network being trained based on a loss function relating to:
(a) a difference between a distribution of the simulated latent variables and a distribution of latent variables corresponding to the training trajectories, and
(b) a reconstruction loss relating to differences between the simulated training trajectories and corresponding training trajectories, wherein the plurality of training datasets correspond to various traffic scenarios and are balanced such that respective counts of the various traffic scenarios are in a same order.

17. A system for simulating a trajectory of an object, comprising:
memory storing computer program instructions; and
one or more processors configured to execute the computer program instructions to effectuate operations including:
obtaining a context feature representation corresponding to context information, wherein the context information comprises information describing an environment of the object;
obtaining a control feature representation corresponding to control information, wherein the control information comprises information that the simulated trajectory needs to satisfy;
determining a latent variable using an input encoder based on the context feature representation and the control feature representation; and
determining the simulated trajectory by inputting the latent variable, the context feature representation, and the control feature representation into a decoder.

18. The system of claim 17, wherein at least one of the context feature representation or the control feature representation comprises information in a form of a feature vector or a subgraph.

19. The system of claim 17, wherein the operations further comprise:
obtaining a concatenated feature representation by concatenating the context feature representation and the control feature representation; and
inputting the concatenated feature representation to the input encoder to determine the latent variable.

20. The system of claim 17, wherein the context information includes at least one of map information and traffic information.
